(19) United States
(12) Patent Application Publication
(10) Pub. No.: US 2018/0000306 A1
(43) Pub. Date: Jan. 4, 2018

(54) Automatic Floor Cleaning Robot

(71) Applicant: Mini-Mole LLC, Danvers, MA (US)

(72) Inventor: Philip J Caruso, Danvers, MA (US)

(21) Appl. No.: 15/544,652

(22) PCT Filed: Jan. 29, 2016
(86) PCT No.: PCT/US16/15507

§ 371 Date: Jul. 19, 2017

Related U.S. Application Data
(60) Provisional application No. 62/110,482, filed on Jan. 31, 2015.

(51) Int. Cl. A47L 11/40; A47L 11/24; G05D 1/00; G05D 1/02

(52) U.S. Cl. CPC A47L 11/4011; A47L 11/4005; G05D 1/0255; G05D 1/0242; G05D 1/0227; A47L 11/4008; A47L 11/24; A47L 11/4066; A47L 11/4061; A47L 11/4038; G05D 1/0088; G05D 2201/0203; A47L 2201/04

(57) ABSTRACT

The present invention is a mobile robot with an attached cleaning element and capable of autonomously seeking areas with low overhead clearance. In the preferred embodiment is a mobile robot using an array of upward facing distance sensors in communication with a controller to detect the presence of obstructions or surfaces above the apparatus. The controller directs the movements of the mobile robot through the use of a drive system, using pattern recognition to avoid becoming stuck and using random movements to increase floor coverage.

### CROSS REFERENCE TO RELATED APPLICATIONS

This application claims the benefit of U.S. Provisional Patent Application No. 62/110,482, filed Jan. 31, 2015, which is hereby incorporated by reference in its entirety.

### FIELD OF THE INVENTION

The present invention relates to cleaning devices, and more particularly to robotic cleaning devices.

### BACKGROUND OF THE INVENTION

Over the years, various robotic devices have been devised to clean or vacuum floors and other surfaces. The use of a mobile robot with a cleaning head is known in the art as a solution to the need for autonomous and automatic floor cleaning devices. The robotic cleaners in the prior art can use a vacuum cleaner head or a sweeping attachment to clean floors as they move.

While robotic cleaners have gotten smaller over time, even the current robotic cleaners are too large to fit under low horizontal obstructions, such as the area under an entertainment console or sideboard. Open areas in a room can be cleaned using conventional techniques or a robotic cleaner, but neither is capable of easily cleaning under low furniture. Because these areas with low overhead clearance can only be cleaned by moving the obstructing furniture, they often go without cleaning for prolonged periods of time. Therefore, there is a need for a device that is able to automatically identify areas in a room with low overhead clearance and that has the capability to clean those areas.

While the robotic cleaners in the prior art are capable of vacuuming or sweeping a room with stationary objects, they are unable to adjust to changes in the environment (e.g. a chair moving). Existing robotic cleaners often use an array of sensors coupled with a preset expanding pattern or a creeping line pattern to cover an entire room. These navigation systems are only effective in simple and static environments and are prone to problems in dynamic environments where a previously identified object moves. Other robotic cleaners in the prior art use a random pattern consisting of operating in a straight line until an obstruction is detected. This programming can cause the robot to be stuck in a corner or within a small area with multiple obstructions, such as under a table and chairs. Therefore, there is a need for a robotic cleaner with a navigation system capable of adapting to a dynamic environment.

The robotic cleaners in the prior art are also prone to getting stuck in corners or falling off raised areas, such as off a stair. A solution in the prior art includes the use of complex electronic boundaries set into the navigation programming, but this only provides parameters for operation without providing an algorithm for determining when the robot is in danger of becoming stuck. Other solutions in the prior art use reactive systems to detect when the robot is stuck to merely turn the device off. The cleaning robots in the prior art are unable to determine when they are in danger of becoming stuck and initiating an action to avoid the situation. When stuck, the cleaning robots in the prior art are also inefficient at freeing themselves due to their large size and weight. Therefore, there is a need for a robotic cleaner that is capable of detecting when it is at risk of becoming stuck so that it can initiate a movement to avoid the condition. There is also a need for a robotic cleaner capable of efficiently freeing itself in the event it does become stuck on an obstruction.

Existing robotic floor sweepers use a rectangular cleaning pad located in front of the robot. The rectangular pusher pads are unable to clean in corners or small gaps and tend to push dirt into the corners of a room rather than collecting it. The pusher style of cleaning pad is prone to becoming stuck on small irregularities in the floor surface and requires a relatively heavy robot to provide adequate traction to push the cleaning pad. Therefore, there is a need for a robotic cleaner with a cleaning pad that is capable of cleaning corners and capable of moving over small irregularities on the surface of a floor.

Accordingly, it is an object of the present invention to provide a robotic cleaner capable of fitting under areas with low overhead clearance and targeting those areas for cleaning. It is also an object of the present invention to provide a robotic cleaner that is capable of adapting to a dynamic environment and detecting when it is in danger of becoming stuck to avoid the condition. It is also an object of the present invention to provide a lightweight mobile robot and cleaning pad attachment capable of cleaning in corners and under low furniture.

### BRIEF SUMMARY OF THE INVENTION

The present invention is a robotic floor cleaning apparatus comprising a mobile robot with a detachable cleaning element extending from the bottom of the mobile robot. The mobile robot comprises a case containing a micro-controller, a power supply, two or more wheels and associated drive motors, upward facing ultrasonic sensors, collision detection sensors and downward facing infrared transmitters and receivers. The present invention can use multiple types of detachable cleaning elements, including disposable and reusable versions.

The present invention uses a navigation system that in one mode, uses the data collected from the upward facing ultrasonic sensors to target areas in a room with a low overhead clearance for cleaning. The navigation system is also capable of detecting patterns in the mobile robot's movements that are precursors or indicative of the mobile robot being stuck and uses a variety of preprogrammed motions to avoid the situation. The navigation system specifically uses an algorithm that randomizes the movements of the apparatus and reacts to the environment to provide more thorough floor coverage than possible using the navigation systems in the prior art.

While the invention described has been described as being particularly applicable to robotic cleaners, it is appreciated that the present invention could be used in other applications within the scope of the inventive concept.

### BRIEF DESCRIPTION OF THE SEVERAL VIEWS OF THE DRAWINGS

FIG. 1 is a perspective view of the robotic floor cleaning apparatus with a first embodiment of a disposable cleaning element attached.

FIG. 2 is a perspective view of the robotic floor cleaning apparatus with the top cover removed and with a first embodiment of a disposable cleaning element attached.

FIG. 3 is a top view of the robotic floor cleaning apparatus with the top cover removed and with a first embodiment of a disposable cleaning element attached.

FIG. 4 is a bottom view of the robotic floor cleaning apparatus with the bottom cover removed.

FIG. 5 is a front view of the robotic floor cleaning apparatus with a first embodiment of a disposable cleaning element attached.

FIG. 6 is a side view of the robotic floor cleaning apparatus with the top cover removed and with a first embodiment of a disposable cleaning element attached.

FIG. 7 is a bottom view of the robotic floor cleaning apparatus without a cleaning element attached.

FIG. 8 is a bottom view of the robotic floor cleaning apparatus with a first embodiment of a disposable cleaning element attached.

FIG. 9 is a perspective view of a first embodiment of a disposable cleaning element.

FIG. 10 is a perspective view of a first embodiment of a reusable cleaning element.

FIG. 11 is a perspective view of a second embodiment of a disposable cleaning element.

FIG. 12 is a perspective view of a second embodiment of a reusable cleaning element.

FIG. 13 is a block diagram of the apparatus.

FIG. 14 is a flow chart showing the operations carried out by the apparatus.

FIG. 15 is a flow chart showing the operations carried out by the apparatus when in the clean step.

FIG. 16 is a flow chart showing the operations carried out by the apparatus when in the backup and spin step.

FIG. 17 is a flow chart showing the operations carried out by the apparatus when in the move forward step.

FIG. 18 is a flow chart showing the operations carried out by the apparatus when in the forward under step.

FIG. 19 is a flow chart showing the operations carried out by the apparatus when in the spiral outward step.

### DETAILED DESCRIPTION OF THE INVENTION

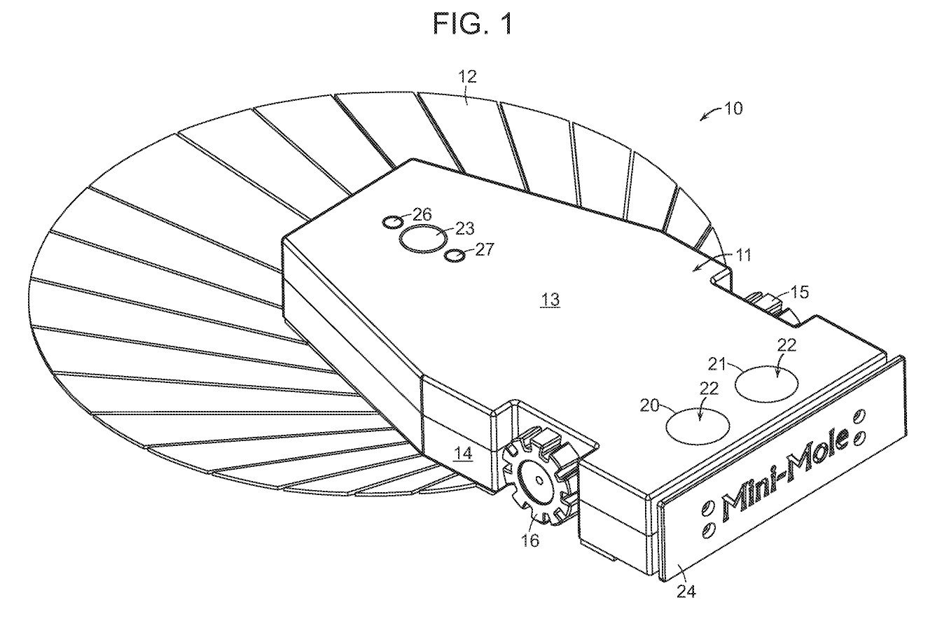

FIG. 1 shows the apparatus of the present invention 10 in an exemplary configuration as a robotic floor sweeper. The apparatus 10 comprises a mobile robot 11 with a first embodiment of a detachable disposable cleaning element 12 attached to the underside of the mobile robot and in contact with the surface to be cleaned. The mobile robot 11 includes an upper case 13 and a lower case 14 that provide the main body of the mobile robot and support for the internal components. Providing propulsion are a left wheel 15 and a right wheel 16 driven by electric motors not seen in this view.

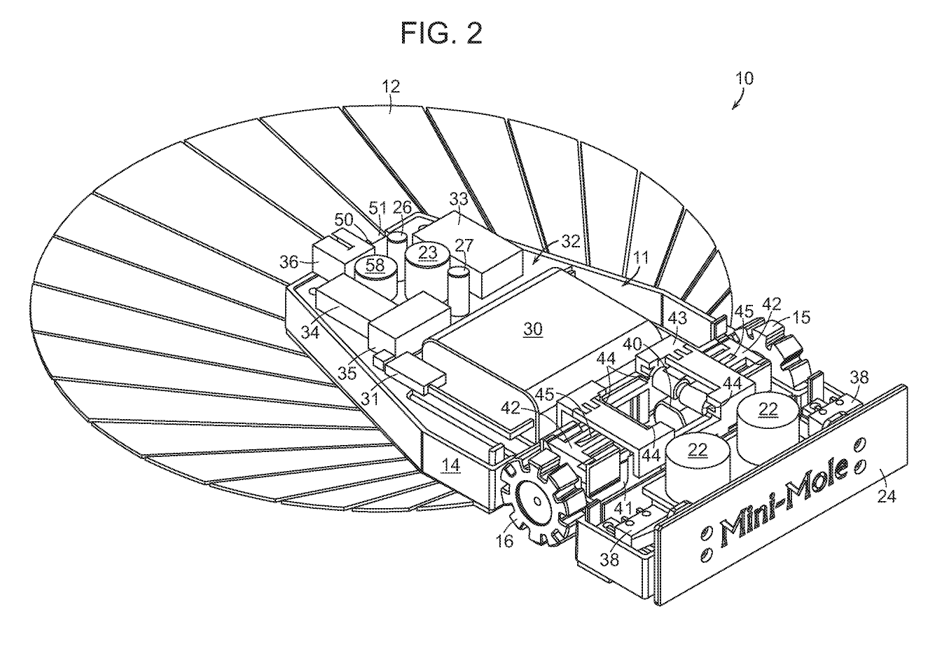

The mobile robot 11 includes a variety of sensors connected to an internally mounted micro-controller 33 (visible in FIG. 2). Visible through openings 20 and 21 in the upper case 13 are upward facing ultrasonic sensors 22. The ultrasonic sensors 22 are used to detect the height of surfaces above the mobile robot 11. At the front of the mobile robot 11 is a bumper 24 capable of displacing switches on internally mounted collision sensors (not shown in this view).

Also visible through openings in the upper case 13 are a power switch 23, a trouble light 26 and a status light 27. The trouble light 26 illuminates when certain problems are detected by the mobile robot 11. The status light 27 is green in normal operation and changes in its lighting configuration can be used to indicate different modes of the apparatus 10. In the preferred embodiment, the trouble light 26 and status light 27 are LED lights, but it is appreciated that multiple types of lights are available in the art and capable of being used in this application.

FIG. 2 contains a perspective view of the apparatus 10 with a first embodiment of a disposable cleaning element 12 attached and the top cover 13 removed (not shown in this view). The top cover 13 and the bottom cover 14 contain multiple internally molded partitions and extrusions to sandwich and securely hold the internal components when the top cover 13 and bottom cover 14 are fastened together. The top cover 13 and bottom cover 14 can be fastened using mechanical fasteners or an adhesive. In FIG. 2, the top cover 13 has been removed, leaving the internal components sitting on the bottom cover 14.

The power supply 30 comprises a battery or other electrical storage device. The preferred embodiment uses a NiMH (Nickel metal hydride) battery, but it is appreciated that multiple types of electrical storage devices would be appropriate for this application. Electrically connected to the battery 30 is a connector 31, also connected to the power printed circuit board (“PCB”) 32.

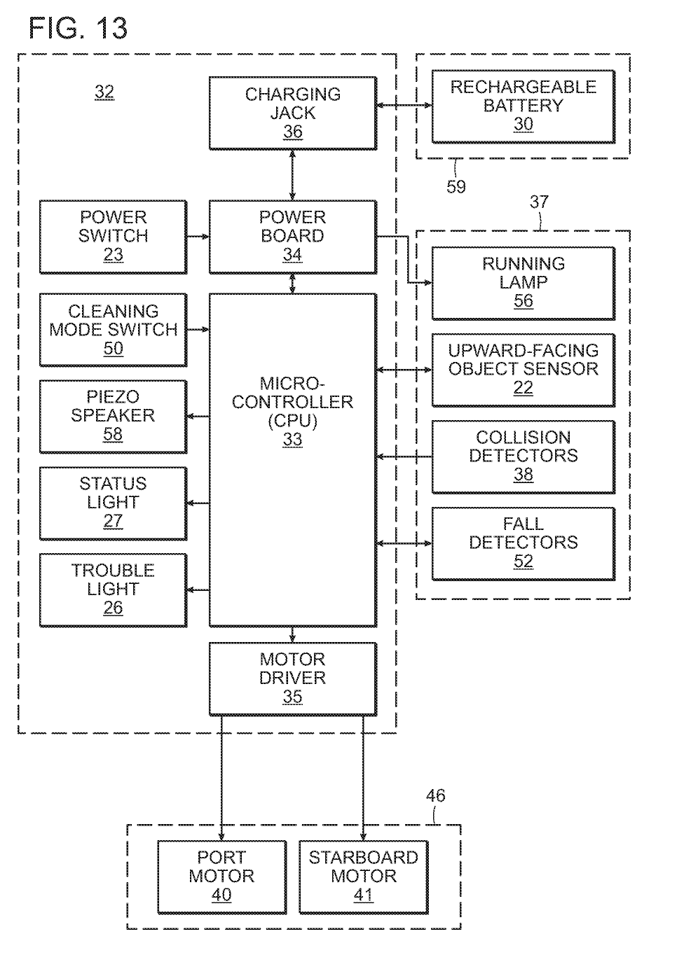

The power PCB 32 contains a micro-controller 33, a power board 34, a motor driver 35 and a charging port 36. The power button 23, trouble light 26 and status light 27 are also mounted to the power PCB 32. The specific functions and the interrelationship of these components is discussed in further detail in the block diagram of FIG. 13 and its associated description in the specification.

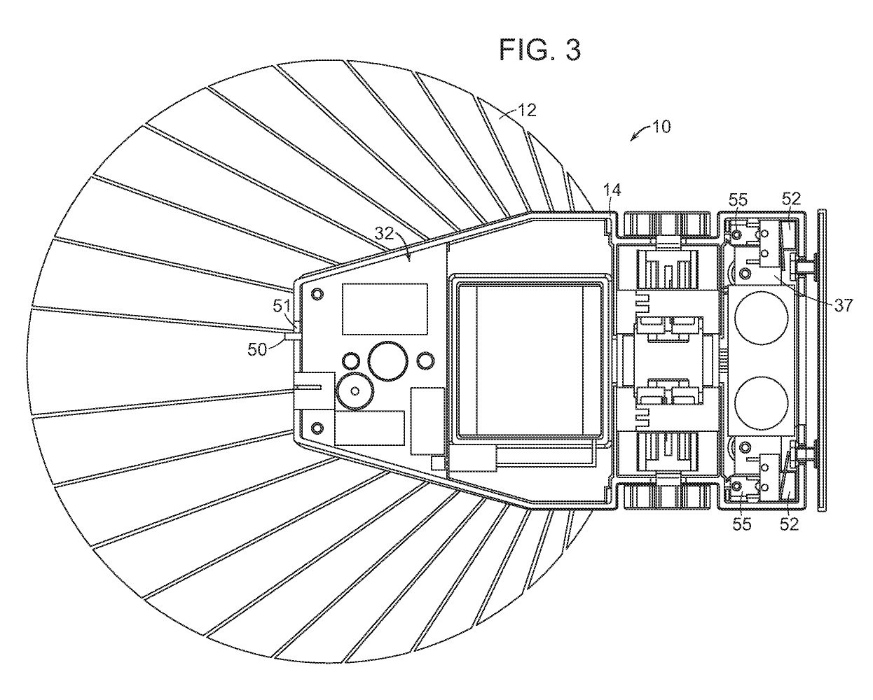

Mounted towards the front of the apparatus 10 are the ultrasonic sensors 22 and collision sensors 38. The ultrasonic sensors 22 are electrically connected to and mounted above a sensor PCB 37 which is not visible in this view (the sensor PCB 37 is visible in FIG. 3). The collision sensors 38 are fixed to the sensor PCB 37 and detect when the bumper 24 is displaced towards the collision sensors 38.

The left electric drive motor 40 and right electric drive motor 41 are mounted on movable arms 42 and coupled to their respective drive wheels 15 and 16 through a reduction gear assembly. The movable arms 42 are mounted to suspension cage 43 at pivots 44, allowing the movable arms to rotate in a limited range about an axis substantially parallel to the longitudinal axis of the mobile robot 11. Between the movable arms 42 and the suspension cage 43 are springs 45 which push the movable arms 42 downward. When at rest, the movable arms 42 are at their lower rotational limit and deflect upwards when in motion, in reaction to surface irregularities.

FIG. 3 contains a top view of the apparatus 10 with a first embodiment of a disposable cleaning element 12 attached and the top cover 13 removed (not shown in this view). Similar to FIG. 2, the internal components are resting on the bottom cover 14 in this view. Visible in this view is the selector switch 50 mounted to the underside of the power PCB 32. The selector switch extends through opening 51 between the upper case 13 (not shown in this view) and lower case 14. In the preferred embodiment, the selector switch 50 is used to cycle the apparatus 10 between various cleaning modes.

Also visible in FIG. 3 is the sensor PCB 37, which is electrically connected to the power PCB 32. In the preferred embodiment, the sensor PCB 37 is connected to the power PCB 32 using a six cable connector. Below the sensor PCB 37 are the infrared transmitters 52, used as fall detectors. The infrared transmitters 52 are downward facing and detect the presence of the ground beneath the apparatus 10. When the infrared transmitters stop detecting the ground under the apparatus 10, the micro-controller interprets this change as a fall or impending fall depending on the duration of the signal. The infrared transmitters 52 are mounted to the bottom case 14 using brackets 55.

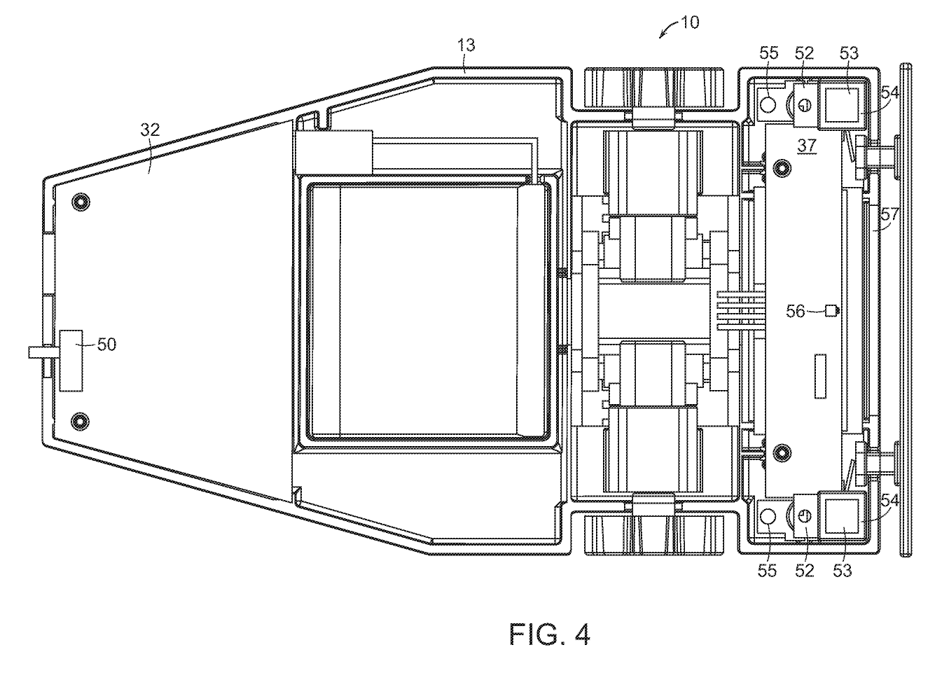

FIG. 4 contains a bottom view of the apparatus 10 with the bottom cover 14 removed (not shown in this view). In this view the internal components are resting on the top cover 13 as they would be if the apparatus 10 was inverted. In this bottom view, the underside of the power PCB 32 and the sensor PCB 37 are visible. On the underside of the power PCB 32 is selector switch 50. On the underside of the sensor PCB 37 is a path illuminating light 56. The path illuminating light 56 is used to illuminate the front of the apparatus 10 and make it more visible to people in the area. There is an opening between the upper case 13 and lower case 14 containing a clear plastic lens 57 to allow the light from the path illuminating light 56 to travel through the case.

Also visible in FIG. 4 are the infrared transmitters 52 and their associated brackets 55. The brackets 55 are normally fixed to the bottom case 14, however, as this is a bottom view, the infrared transmitters 52 and brackets 55 are merely placed in the upper case 13 to show their arrangement. Also in this view are the clear lenses 53 mounted to the bottom case 14 using a skirt 54 that snaps into an opening on the bottom case 14 to hold the assembly.

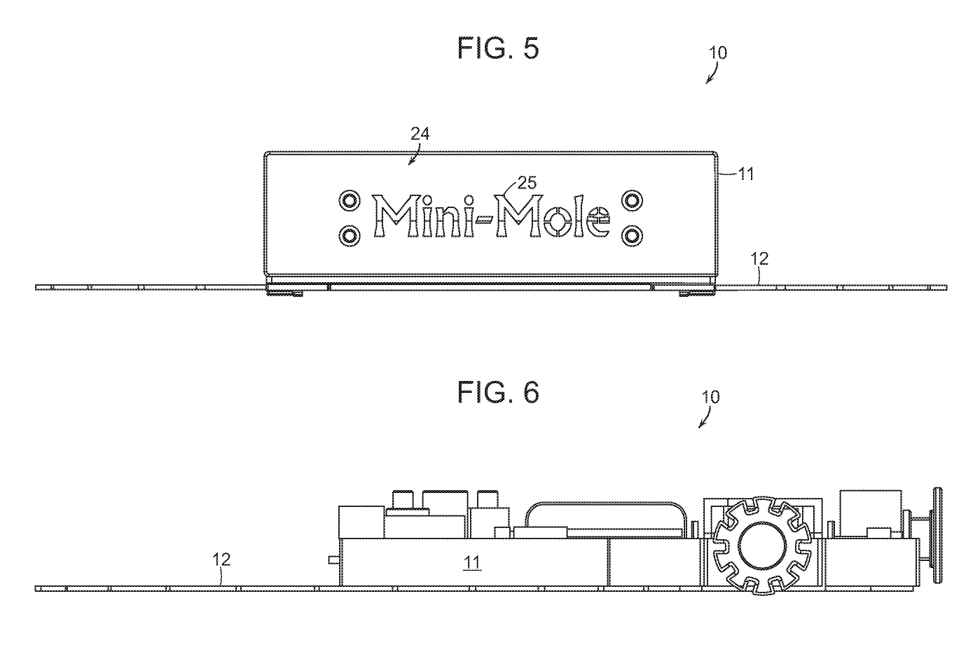

In FIGS. 5 and 6 are views of the apparatus 10 with a first embodiment of a detachable disposable cleaning element 12 attached to the underside of the mobile robot 11. In FIG. 5 is a front view of the apparatus 10 and in FIG. 6 is a side view of the apparatus 10 with the top cover 13 (not shown in this view) removed. The bumper 24 contains a logo 25 cut through the bumper material to allow the light from the path illuminating light 56 to travel through the bumper. In the preferred embodiment, the bumper 24 comprises a rigid plastic base with a rubber or rubberized coating to reduce the amount of sound created when the bumper impacts an obstruction during use. The bumper 24 can alternatively be made entirely of a semi-rigid material to reduce noise or a transparent or semi-transparent material to allow light to pass through without the use of a logo 25 cut through the bumper.

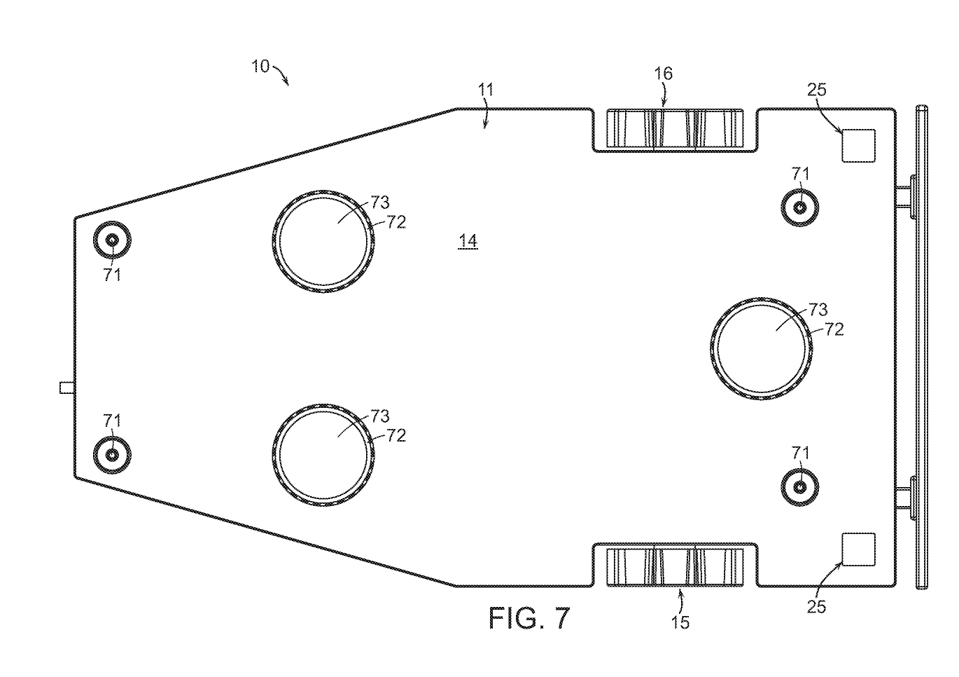

In FIG. 7 is a bottom view of the apparatus 10 without a cleaning pad installed. On the underside of the mobile robot 11 are openings 25 that allow the internally mounted infrared sensors to view the ground ahead of the wheels 15 and 16. Visible in this view are the four screws 71 that secure the lower case 14 to the upper case 13 (not shown in this view). While the preferred embodiment uses screws, other types of mechanical fasteners or an adhesive could be substituted. On the surface of lower case 14 are three recesses 72, each containing a hook and loop fastener 73. The recesses 72 are recessed into the surface of lower case 14 to the depth necessary to make the surface of hook and loop fasteners 73 flush with the surface of the lower case 14. The hook and loop fasteners 73 can be either of the hook or loop variety as long as the type used on a corresponding attachment is of the opposite type. The hook and loop fasteners 73 are secured to the lower case 14 with an adhesive in the preferred embodiment, but it is appreciated that there are other methods in the art to achieve this end.

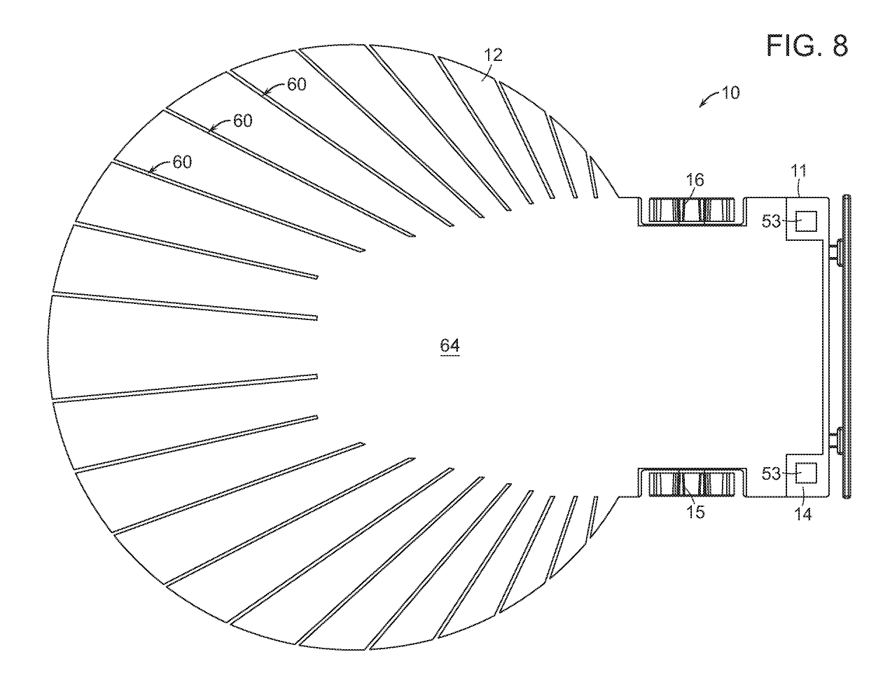

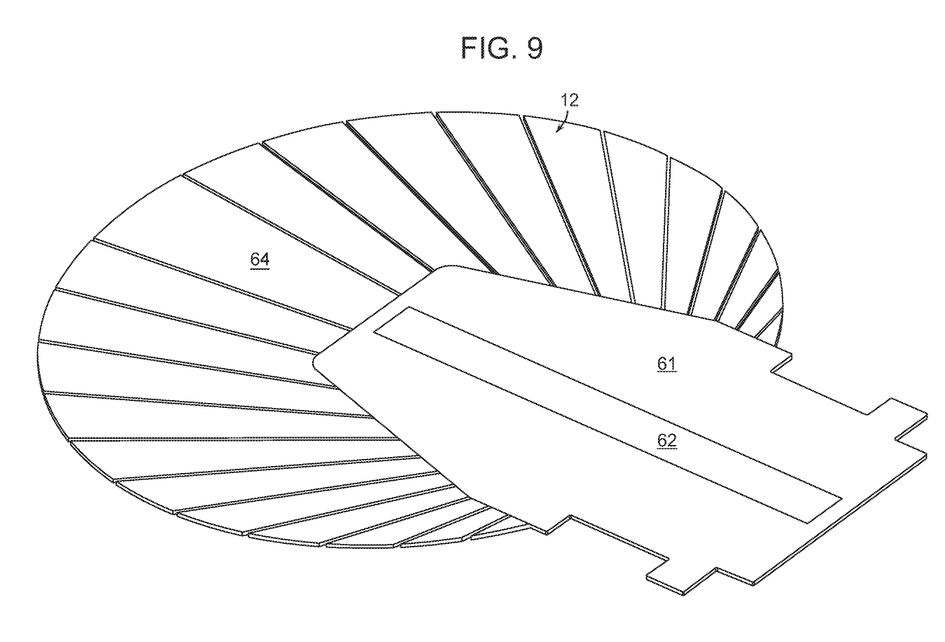

FIG. 8 is a bottom view of the apparatus 10 with a first embodiment of a disposable cleaning element 12 attached to the underside of the mobile robot 11. In the preferred embodiment, the disposable cleaning element 12 is made largely of an electrostatic cleaning cloth 64, however it is appreciated that there are other materials known in the art that can be used as a substitute. The disposable cleaning element 12 has a solid area of electrostatic cleaning cloth 64 in the areas located directly under the bottom case 14. The disposable cleaning element 12 follows the contours of the bottom case 14 and avoids fouling the wheels 15 and 16 or covering the clear lenses 53. On the part of the disposable cleaning element 12 that extends away from the bottom case 14, there are a multitude of slits 60 in the electrostatic cleaning cloth 64 to allow the cleaning element to remain flexible as the mobile robot moves. The shape of the disposable cleaning element 12 and the slits 60 are designed to minimize the possibility of the cleaning element from becoming caught in the wheels 15 and 16. Even when sections of the cleaning element 12 are folded towards the wheels, they are unable to reach the wheels.

The circular shape of the cleaning element 12 combined with the slits 60 complement the navigation programming used in the apparatus 10 and maximize the ability of the apparatus 10 to clean in small corners. When the apparatus turns in corners, the slits 60 allow the material to brush into the corner where a solid cleaning element would bunch up or lift from the surface. The circular shape is also important to the function of the cleaning element 12 and provides a more consistent brushing effect on corners than a rectangular or triangular cleaning element. When the apparatus 10 rotates the circular portion of the cleaning element 12 near a corner, the corner is brushed by each finger of the cleaning material (defined by the slits 60) with an approximately equal amount of force. When a cleaning element with a triangular or rectangular shape extending from the bottom case 14 was tested, the rotation of the apparatus 10 caused the material to bunch up and the cleaning effect of each finger was different, creating an inconsistent cleaning action.

In FIG. 9 is a perspective view of the upper side of a first embodiment of a disposable cleaning element 12. The area of the cleaning element 12 that presses against the bottom case 14 contains a thin layer of plastic 61 for additional support. The plastic 61 prevents the cleaning element 12 from folding away from the bottom case 14 when in motion. In the preferred embodiment, the plastic 61 is an approximately three mil flexible film and the weight of the mobile robot 11 provides the additional force needed to hold the cleaning element 12 in place. To keep the cleaning element 12 from sliding away from the mobile robot 11, there is an adhesive strip 62 attached to the top of the cleaning element 12. In the preferred embodiment, the adhesive strip 62 is double-sided tape, but it is appreciated that multiple types of removable fasteners or adhesives could be used with similar results.

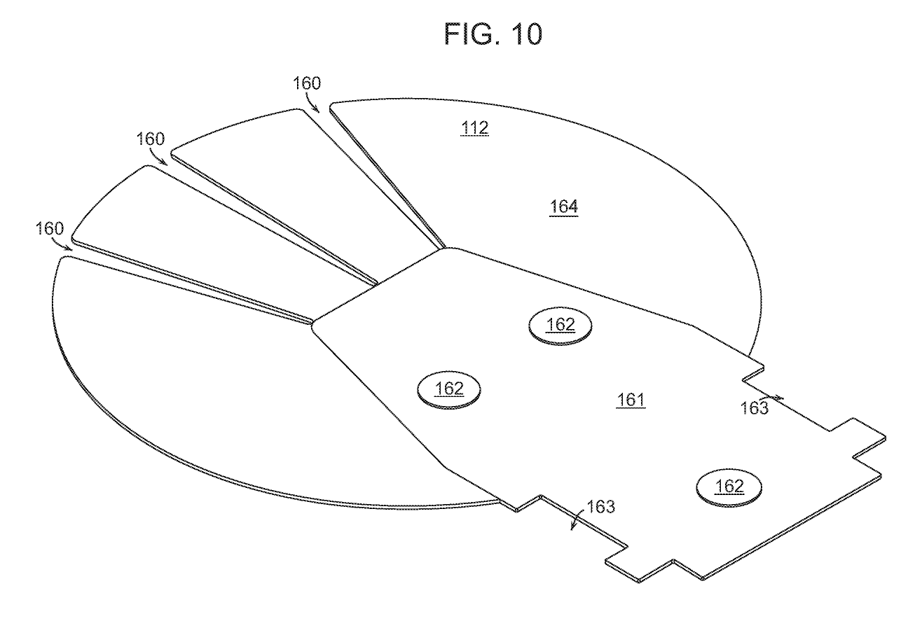

In FIG. 10 is a perspective view of a first embodiment of a reusable cleaning element 112, which can be used as a substitute for cleaning element 12. In this embodiment, the reusable cleaning element 112 is made largely of microfiber cloth 164, however it is appreciated that there are other materials known in the art that can be used as a substitute. The microfiber cloth 164 covers the entire bottom surface of the reusable cleaning element 112. The reusable cleaning element 112 has a similar overall shape as the disposable cleaning element 12, but with detailed differences to optimize its performance. The material used for the reusable cleaning element 112 in this embodiment is softer and more flexible than the material used for the disposable cleaning element 12. Because the reusable cleaning element 112 uses a softer and more flexible material, it is able to remain on the surface as the mobile robot 11 rotates without as many slits 160.

In this alternative embodiment, the reusable cleaning element 112 uses three slits 160 extending away from the bottom case 14. One slit 160 follows the centerline of the apparatus 10, extending rearward. The other two slits 160 extend from the rear corners of the bottom case 14 and extend rearward and to the side. These two slits 160 terminate at a point on the cleaning element 112 that is directly behind the cutouts 163 for the drive wheels. This arrangement allows the cleaning element 112 to slide against a wall easily, while still allowing the mobile robot 11 to rotate and use the rotating motion to move the cleaning element 112 through a corner.

Similar to the disposable cleaning element 12, the reusable cleaning element 112 uses a thin layer of support material 161 to increase the rigidity of the area which it is applied. The support material 161 can be a fabric or other washable material, including some plastics that are durable enough to be washed. To keep the cleaning element 112 centered on the mobile robot 11, multiple hook and loop fasteners 162 are used that correspond to the hook and loop fasteners 73 (visible in FIG. 7) fixed to the bottom cover 14.

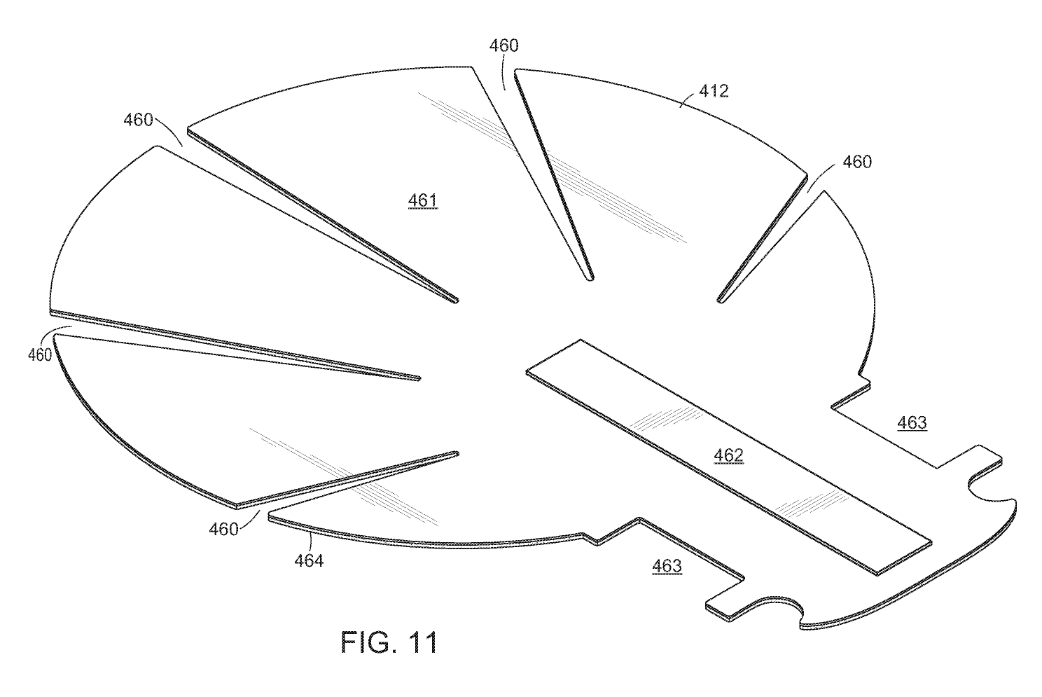

In FIG. 11 is a perspective view of a second embodiment of a disposable cleaning element 412, which can be used as a substitute for cleaning elements 12 and 112. In this embodiment, the disposable cleaning element 412 is made largely of electrostatic cleaning cloth 464, however it is appreciated that there are other materials known in the art that can be used as a substitute. The electrostatic cleaning cloth 464 covers the entire bottom surface of the disposable cleaning element 412.

In this alternative embodiment, the disposable cleaning element 412 uses five slits 460 extending away from the bottom case 14. One slit 460 follows the centerline of the apparatus 10, extending rearward. Two slits 460 extend from the rear corners of the bottom case 14 and extend rearward and to the side. These two slits 460 terminate at a point on the cleaning element 412 that is behind the cutouts 463 for the drive wheels. Two slits 460 extend from the sides of the bottom case 14 and extend rearward and to the side. The disposable cleaning element 412 uses a thin layer of plastic 461 that covers the entire upper surface of the disposable cleaning element 412 to provide additional support. To keep the cleaning element 412 centered on the mobile robot 11, an adhesive strip 462 is attached to the top of the cleaning element 412. In the preferred embodiment, the adhesive strip 462 is double-sided tape, but it is appreciated that multiple types of removable fasteners or adhesives could be used with similar results.

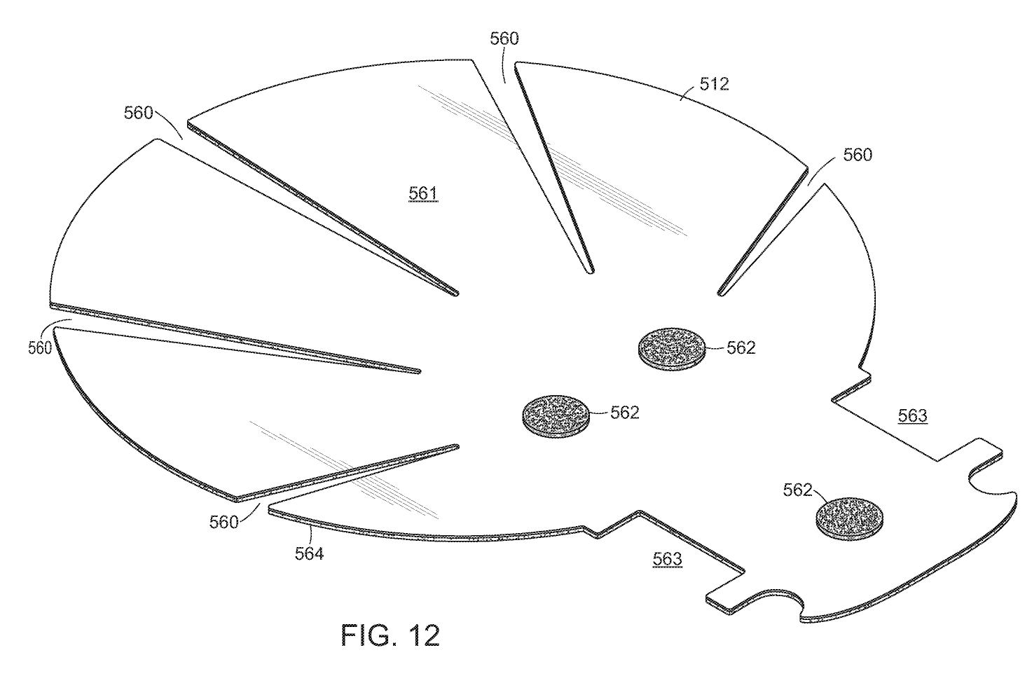

In FIG. 12 is a perspective view of a second embodiment of a reusable cleaning element 512, which can be used as a substitute for cleaning elements 12, 112 and 412. In this embodiment, the reusable cleaning element 512 is made largely of microfiber cloth 564, however it is appreciated that there are other materials known in the art that can be used as a substitute. The microfiber cloth 564 covers the entire bottom surface of the reusable cleaning element 512.

In this alternative embodiment, the reusable cleaning element 512 uses five slits 560 extending away from the bottom case 14. One slit 560 follows the centerline of the apparatus 10, extending rearward. Two slits 560 extend from the rear corners of the bottom case 14 and extend rearward and to the side. These two slits 560 terminate at a point on the cleaning element 512 that is behind the cutouts 563 for the drive wheels. Two slits 560 extend from the sides of the bottom case 14 and extend rearward and to the side. The reusable cleaning element 512 uses a thin layer of support material 561 that covers the entire upper surface of the reusable cleaning element 512 to provide additional rigidity to the cleaning element. The support material 561 can be a fabric or other washable material, including some plastics that are durable enough to be washed. To keep the cleaning element 512 centered on the mobile robot 11, multiple hook and loop fasteners 562 are used that correspond to the hook and loop fasteners 73 (visible in FIG. 7) fixed to the bottom cover 14.

The second embodiment of a disposable cleaning element 412 and the second embodiment of a reusable cleaning element 512 share multiple advantages over the first embodiment of a disposable cleaning element 12 and the first embodiment of a reusable cleaning element 112. Cleaning elements 412 and 512 use a support layer 461 and 561, respectively, that covers the entire top surface of the cleaning element. Cleaning elements 12 and 112 use a support layer 61 and 161, respectively, that covers only the top surface of the cleaning element that is directly below the mobile robot 11. Extending the support layer in cleaning elements 412 and 512 to the entire top surface improves contact with the floor when cleaning and reduces production costs because a single cutting die can be used for the cleaning material 464 and 564 and the support layer 461 and 561. The number of cuts necessary to produce each cleaning element 412 and 512 can be reduced to a single cut by attaching the support layer 461 and 561 to the cleaning material 464 and 564, respectively, prior to being cut with a cutting die.

The extension of the support layer 461 and 561 also blocks dirt from collecting on the upper surface of the cleaning elements 412 and 512, improving their appearance when used for a period of time. In comparison, cleaning elements 12 and 112 tend to collect some dirt on their visible upper surfaces when used.

Cleaning elements 412 and 512 use the same number and placement of slits 460 and 560, respectively. Using the same number and placement of slits allows cleaning elements 412 and 512 to be manufactured using a common, or substantially common, cutting die, reducing manufacturing costs. The common pattern also allows both types of cleaning elements to be dispensed from the same dispenser and fit into a substantially similar package.

In FIG. 13 is a functional block diagram of the major components contained within the apparatus 10. The block diagram is separated by location, with the components mounted on the power PCB 32, the components included in the engine compartment 46, the components mounted on the sensor PCB 37 and the components included in the battery compartment 59 shown in separate groups. The power PCB 32 includes a micro-controller 33 that directs the operations of the cleaning robot. The micro-controller 33 is directly connected to the power board 34, motor driver 35, cleaning mode switch 50, piezo speaker 58, status light 27 and trouble light 26. The motor driver 35 is also connected to the left drive motor 40 and the right drive motor 41. The motor driver 35 can control the speed of the left drive motor 40 and right drive motor 41 independently in forward and reverse. The power board 34 provides power to the components contained in the apparatus from the rechargeable battery 30. The charging jack 36 completes the circuit between the rechargeable battery 30 and power board 34 when a charging cord is not plugged into the charging jack. When a power cord is plugged into the charging jack 36 to recharge the rechargeable battery 30, the charging jack breaks the electrical connection with the power board 34 and directs the power to the rechargeable battery. The power switch 23 is connected to the power board 34 and provides a means for a user to turn the apparatus 10 on or off when a power cord is not plugged into the charging jack 36. In the preferred embodiment, when a power cord is plugged into the charging jack 36, the power board does not receive power from either the charging jack 36 or the rechargeable battery 30.

The components on the sensor PCB 37 are connected directly to and controlled by the micro-controller 33 with the exception of the running lamp 56. The running lamp 56 is energized when the power board is providing power to the micro-controller 33 from the rechargeable battery 30. While the components on the sensor PCB 37 are controlled by the micro-controller 33, they receive power from the power board 34 through an electrical connection not shown in FIG. 13. Incorporated as part of the sensor PCB 37 are the upward facing object sensors 22, the collision detectors 38 and the fall detectors 52. The upward facing ultrasonic sensors 22 are mounted to a controller that is electrically connected to the sensor PCB 37. In the preferred embodiment, the upward facing sensors 22 are capable of sensing objects up to 20 feet above the sensors, however, in this application, the range of the sensors is limited through the software to approximately two feet. The apparatus 10 targets areas in a room with less than 10-12 inches of overhead clearance for cleaning, making it unnecessary to use the full range of the ultrasonic sensors 22 in this embodiment. While the range of the ultrasonic sensors 22 are being limited by the software in this embodiment, it is appreciated that there may be other applications where it would be preferable to use up to the full range of the ultrasonic sensors 22. A larger range from the ultrasonic sensors would be necessary if the apparatus 10 was programmed to target areas with between a 10-12 inch and 20 foot overhead clearance or for the apparatus 10 to detect features above, such as a door frame.

The collision detectors 38 are micro-switches with spring loaded levers. The spring loaded levers push the bumper forward to its resting position and are compressed when the bumper comes in contact with an obstruction. The fall detectors 52 are infrared transmitters and receivers mounted to the bottom of the apparatus 10. The fall detectors 52 send out a signal and time the response back to determine if the ground is directly under the front of the apparatus 10. While infrared transmitters and receivers are used in the preferred embodiment, it is appreciated that there are other types of sensors that would be adequate for this function, including ultrasonic sensors.

The use of infrared sensors as the fall detectors 52 reduces the overall size of and the cost to manufacture the apparatus 10. A challenge with infrared sensors is that they are sensitive to the color and sheen of the floor surface as well as the amount of ambient light. Certain types of floors with large variations in color, such as a black and white tile floor, generate a large number of false positives on cleaning robots in the prior art. Instead of automatically changing the sensitivity of the infrared sensors, the cleaning robots in the prior art require the user to manually reduce the overall sensitivity of the fall sensors to allow the cleaning robot to travel over surfaces that would otherwise trigger false positives of falling, effectively disabling the fall detection system. To reduce the occurrence of false positives while maintaining the functionality of the fall detectors in all conditions, the preferred embodiment uses the first three seconds of operation to calibrate the infrared sensors. During the first three seconds of the cleaning cycle, the micro-controller 33 records the high values taken from the fall detectors 52 to obtain a range of normal values for the floor type and current lighting conditions. By using the range of values obtained by the infrared sensors in the current cleaning cycle, the apparatus 10 is able to adapt to the current conditions and reduce the chance of false positives that it is falling.

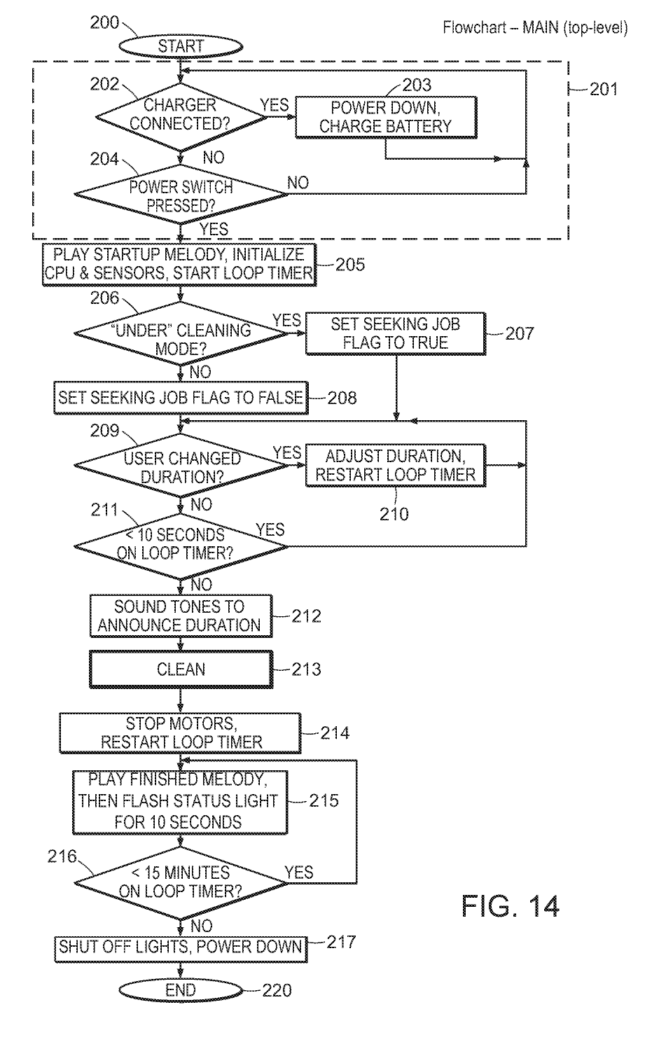

In FIGS. 14-19 are flow charts showing the operations carried out by the apparatus 10 in the preferred embodiment. Steps in each flow chart that are defined further in a separate figure are denoted by a bold box. The flow charts shown are exemplary in nature and are capable of being changed or modified within the scope of the invention.

In FIG. 14 is a flow chart showing the functions carried out by the micro-controller 33 during a full cleaning cycle. After the start 200 of the flow chart and before any functions are carried out by the micro-controller 33, the apparatus goes through a hardware based sequence 201. The hardware based sequence can occur at any point during the cleaning cycle and does not require explicit checking by the micro-controller 33 to sense a change in the hardware based settings. The first step in the hardware based sequence 201 is to determine whether a charger is connected 202, specifically, whether a charging cord is plugged into the charging port. When a power cord is plugged in, the apparatus powers down and charges the battery 203. When a power cord is not plugged in, the apparatus then checks whether the power switch has been pressed 204. If the power switch has been pressed, the flow chart exits the hardware based sequence 201 and continues to the software based sequence that makes up the majority of a full cleaning cycle.

With power flowing to the micro-controller, the first software step in the sequence is to play a startup melody, initialize the CPU and sensors and start the loop timer 205. The micro-controller then detects whether the under cleaning mode has been selected by the user 206. The under cleaning mode (also referred to as the “clean under” mode herein) directs the apparatus to clean areas of a room under objects. As stated earlier, the preferred embodiment considers an overhead obstruction height of less than approximately 10-12 inches over the top of the apparatus as being located under an object. The under cleaning mode is selected by the user through the selector switch 50 (visible in FIGS. 3 & 4). If the user has selected the under cleaning mode, the micro-controller sets the seeking job flag to true 207. If the under cleaning mode has not been selected, the micro-controller sets the seeking job flag to false 208. The seeking job flag status is used at various points in the clean step 213 to optimize the path of the apparatus according to the user's cleaning preference. The micro-controller then checks whether the user has changed the duration of the cleaning cycle 209. In the preferred embodiment, the user is able to change the length of the cleaning cycle during the first ten seconds after the power switch has been pressed by triggering the collision sensors (by pressing the bumper). When the user has changed the duration by pressing the bumper, the duration of the cleaning cycle is adjusted as the loop timer that initially started in step 205 is restarted 210. When more than ten seconds have elapsed on the loop timer 211, the apparatus sounds a tone to announce the duration of the cleaning cycle 212 and then begins to clean 213.

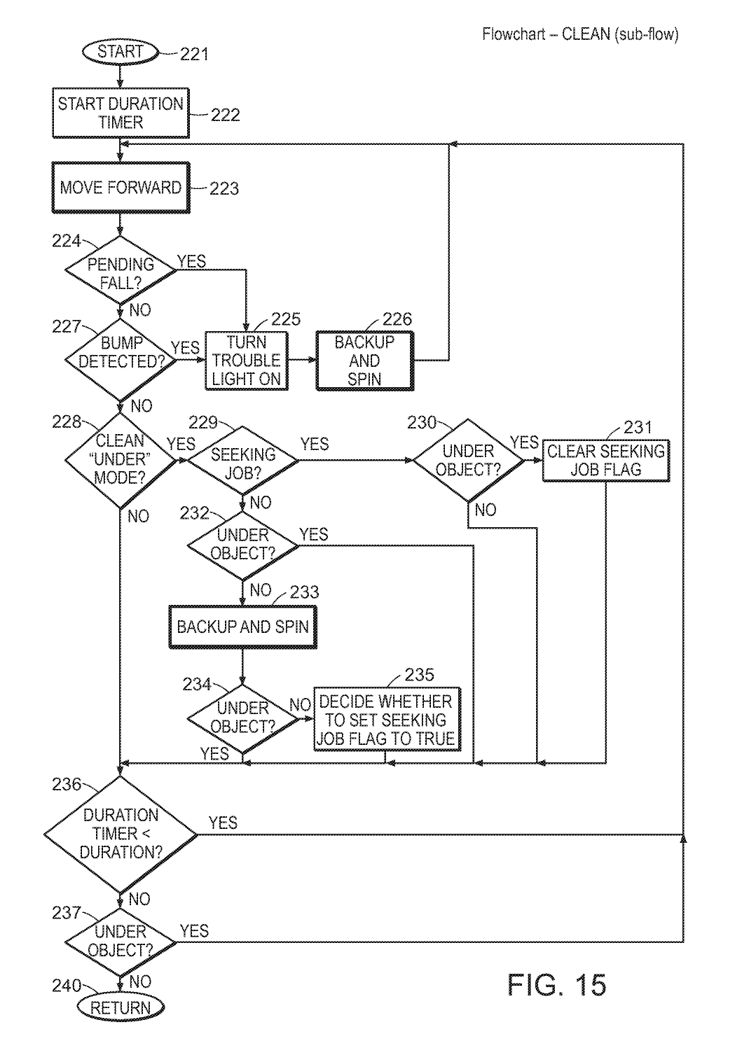

The clean step 213 is further defined in FIG. 15 to detail the specific steps that are included in the sequence. When the clean step 213 is complete, the apparatus stops the motors and restarts the loop timer 214. The apparatus then plays a finished melody and then flashes the status light for 10 seconds 215 to alert the user that the cleaning cycle is complete and continues to do so until more than 15 minutes have elapsed on the loop timer 216. During the 15 minute delay, the user can either shut the apparatus off using the hardware based sequence 201 by pressing the power switch or by letting the loop timer pass 15 minutes 216. When the loop timer passes 15 minutes 216, the apparatus shuts off the lights and powers down 217, ending the full cleaning cycle 220.

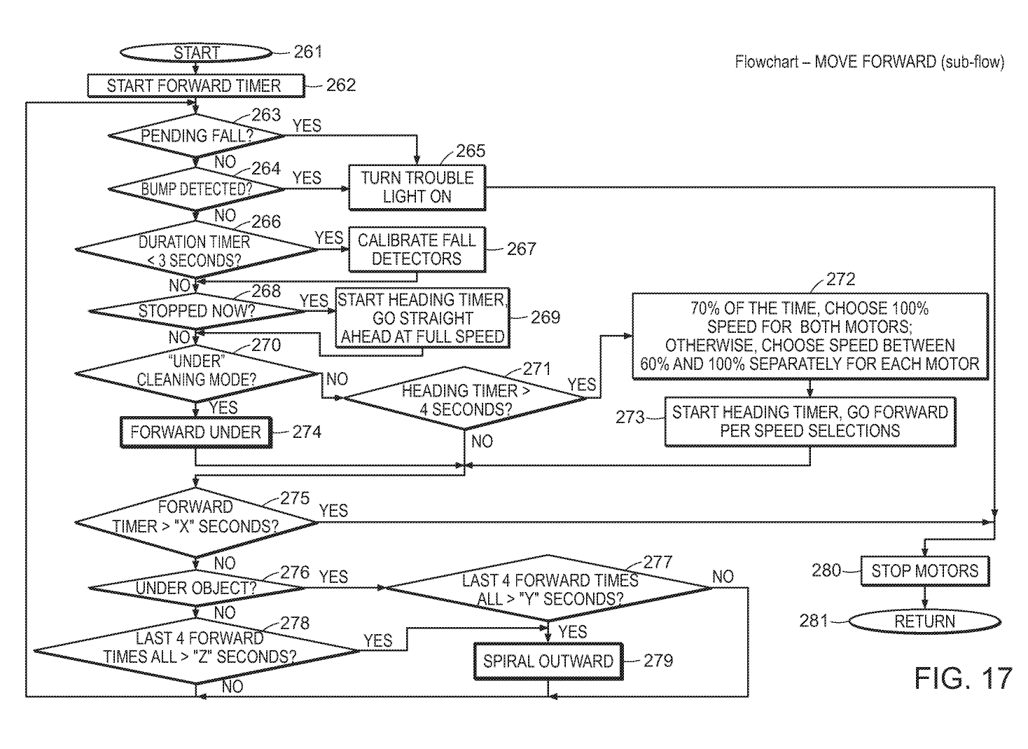

In FIG. 15 is a flow chart detailing the sequence used by the apparatus under the clean step 213 in FIG. 14. After the clean step starts 221, the micro-controller starts the duration timer 222. The micro-controller then initiates the move forward step 223. The move forward step is further defined in FIG. 17 to detail the specific steps that are included in the sequence. When the move forward step 223 is complete, the apparatus checks whether there is a pending fall 224 indicated by the fall sensors or if there has been a bump detected by the collision sensors 227. If either of these conditions exist, the micro-controller turns on the trouble light 225 and initiates the backup and spin sequence 226.

When the move forward step 223 is complete and a fall is not pending 224 and a bump has not been detected 227, the apparatus checks whether the clean under mode has been selected by the user 228. When the clean under mode has been selected, the apparatus checks whether the seeking job flag is set to true 229. If the seeking job flag is set to true, it then uses the upward facing ultrasonic sensors 22 (visible in FIGS. 1 & 2) to determine if the apparatus is located under an object 230. If the apparatus is under an object, the micro-controller sets the seeking job flag to false 231.

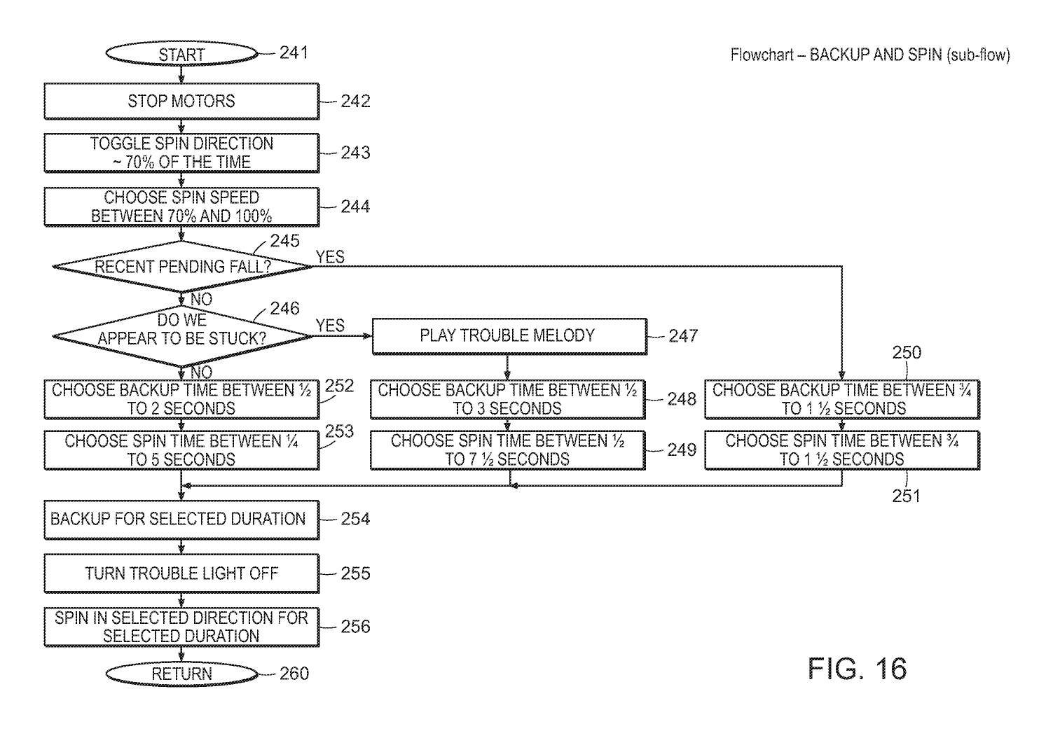

When the apparatus is not seeking a job in step 229, the apparatus uses the upward facing ultrasonic sensors 22 (visible in FIGS. 1 & 2) to determine if the apparatus is located under an object. If under an object, the micro-controller continues to the next step. If not under an object, the apparatus will backup and spin 233, a process explained in further detail in FIG. 16. After the backup and spin step 233, the apparatus will again check whether it is under an object 234. If under an object, the micro-controller will move along to the next step. If not under an object, the micro-controller will decide whether to set the seeking job flag to true before continuing 235. In the preferred embodiment, the micro-controller decides to set the seeking job flag to true in step 235 approximately 40% of the time. The micro-controller can alternatively decide to set the seeking job flag to true in step 235 at a different frequency, such as approximately 25% of the time.

The next step in the clean flow chart is a check by the micro-controller if the duration timer that was started in step 222 is less than the cleaning cycle selected by the user in step 209 (in FIG. 14). If the duration timer has not exceeded the length of the cleaning cycle selected by the user, the micro-controller will loop back to the move forward step 223. If the duration timer has exceed the length of the cleaning cycle, the micro-controller will determine once again whether it is under an object 237. To avoid having the apparatus end a cleaning cycle under an object, the micro-controller will loop back to the move forward step 223 if located under an object at the end of the cycle. When the apparatus is not under an object and the duration timer has exceeded the duration of the cleaning cycle selected by the user, the clean step will end 240.

In FIG. 16 is a flow chart detailing the backup and spin function 226 and 233 in FIG. 15. When the backup and spin flow chart has been initiated 241, the micro-controller first stops the motors 242. The micro-controller will then decide a direction to begin a spin 243. Approximately 70% of the time, the chosen spin direction will be in a different direction than the last spin. The micro-controller then decides on a spin speed by directing each motor to spin in an opposite direction at between 70 and 100 percent 244, where the percentage indicates the shaft speed of the motor in relation to its maximum shaft speed under load. The variable spin rates help the apparatus free itself when it is stuck or in danger of being stuck.

To reduce the chances of the apparatus backing off or spinning off a ledge, the micro-controller then checks if it has had a recent pending fall 245. A recent pending fall will take the form of a recent event where the downward facing infrared sensors 52 (visible in FIG. 4) have sensed a fall or a lack of ground under the front of the apparatus. When a recent fall has been detected, the micro-controller will direct a less aggressive backup and spin, choosing a backup time of between 0.75 to 1.50 seconds 250 and a spin time of between 0.75 and 1.50 seconds 251.

If a recent fall has not been detected in step 245, the micro-controller will then check if the apparatus appears to be stuck 246. The apparatus does not need to be physically unable to move for the micro-controller to consider it stuck, but rather can be merely moving in a small partially enclosed area, such as under a chair or under a piece of furniture in a corner. The apparatus considers itself to be stuck when there have been four hits on the bumper 24 (visible in FIG. 1) within the previous four seconds of forward motion and the last period of forward motion was less than two seconds. The micro-controller starts a timer each time the apparatus moves forward and keeps the previous four forward elapsed times in memory on a rolling basis. When the micro-controller determines that the apparatus is stuck in step 246, the apparatus plays a trouble melody 247 and chooses an extended backup time of between 0.50 and 3.00 seconds 248 and an extended spin time of 0.50 to 7.50 seconds 249. If the apparatus is not stuck, the micro-controller chooses an intermediate backup time of 0.50 to 2.00 seconds 252 and an intermediate spin time of 0.25 to 5.00 seconds 253. The micro-controller chooses an extended backup and spin time when the apparatus is stuck to remove itself from the partially enclosed area that has obstructed its movement over the previous four periods of forward motion.

Once the backup and spin times have been selected by the micro-controller, the apparatus executes the selected backup 254. While the micro-controller will select a power level for each motor and a duration, in the preferred embodiment, the motor does not run at the selected power level for precisely the duration selected. To avoid stressing the motor and gears, the motor speeds are increased over a span of milliseconds rather than instantaneously. After the backup is complete, the micro-controller turns off the trouble light 255 (if it was energized) and directs the apparatus to execute the selected spin 256. Once the spin is complete, the backup and spin sequence is complete 260.

In FIG. 17 is a flow chart detailing the move forward step 223 in FIG. 15. After the move forward sequence begins 261, the micro-controller starts the forward timer 262. The forward timer runs for the entire duration of each move forward sequence and provides the basis for the forward elapsed times used to choose the duration of the backup and spin in FIG. 16. The micro-controller then polls the sensors to determine if the apparatus is about to fall 263 or if the collision sensors have been triggered 264. Either event causes the trouble light to turn on 265, the motors to stop 280 and the move forward sequence to end 281.

If neither a pending fall nor bump are detected, the micro-controller determines if the duration timer that was started in step 222 (in FIG. 15) is less than three seconds. If the duration timer is less than three seconds, the micro-controller will calibrate the fall detectors 267 by calculating and storing the maximum values recorded during the first three seconds of the duration timer. In the preferred embodiment, the fall detectors calculate a value based on the amount of time elapsed between the transmission and receipt of an infrared pulse and the intensity of the return pulse. The precise values generated by the fall detectors will depend on the specific infrared sensors (or other type of sensor capable of detecting distance) used in the application. For infrared sensors in general, surfaces that are further away generate higher values. Darker and matte surfaces generate higher values because they reflect less light than lighter and glossy surfaces, making them appear further away to an infrared sensor. The apparatus will continue to operate during the time when the micro-controller is calibrating the fall detectors to ensure that multiple areas of the surface to be cleaned are sensed in the initial calibration.

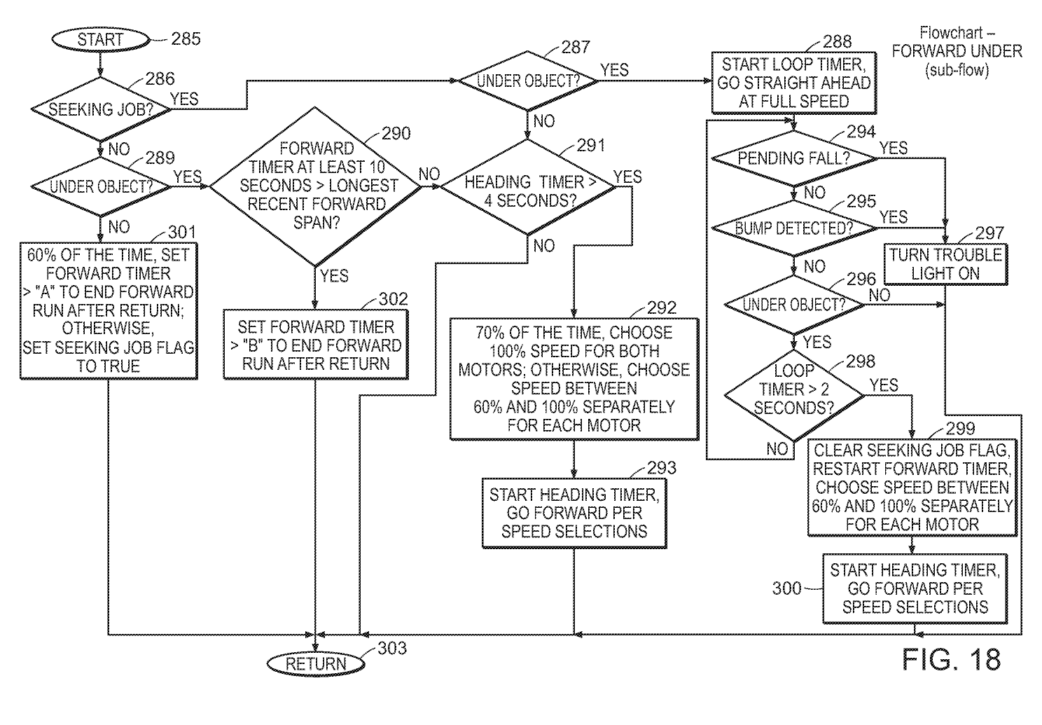

If the apparatus is stopped at step 268, the micro-controller will start a heading timer and direct the apparatus to move forward at full speed 269. If the apparatus is not stopped in step 268, the micro-controller will move directly to the next step where it determines if the under cleaning mode has been selected by the user 270. If the under cleaning mode has been selected by the user, the micro-controller will initiate the forward under sequence 274 that is shown in further detail in FIG. 18.

If the under cleaning mode has not been selected in step 270, the micro-controller will then determine if the heading timer has run for more than four seconds 271. When the heading timer has run for more than four seconds, 70 percent of the time, the micro-controller will select a new forward speed, setting both motors forward at 100 percent and 30 percent of the time, the micro-controller will select a new forward speed, setting each motor forward at 60 to 100 percent 272. Once the new forward speed is selected in step 272, the micro-controller restarts the heading timer and directs the apparatus to move forward at the selected speed 273.

In the next step in the move forward sequence, the micro-controller determines if the forward timer that began in step 262 has exceeded “X” seconds 275. In the preferred embodiment, the micro-controller sets “X” to 25 so that in step 275, the micro-controller determines whether the forward timer has exceeded 25 seconds. The micro-controller can alternatively decide to set “X” as a different value, such as 60.

When “X” seconds have elapsed, the micro-controller stops the motors 280 and the move forward sequence is ended 281. If the forward timer has not exceeded “X” seconds in step 275, the micro-controller then begins to determine whether the apparatus is operating in a large open space, such as under a bed or in a large room. The micro-controller first polls the upward facing ultrasonic sensors to determine if the apparatus is located under an object 276. If under an object, the micro-controller checks if the last four forward times have all exceeded “Y” seconds 277. In the preferred embodiment, the micro-controller sets “Y” to two so that in step 277, the micro-controller determines whether the last four forward times have all exceeded two seconds. The micro-controller can alternatively decide to set “Y” as a different value, such as three.

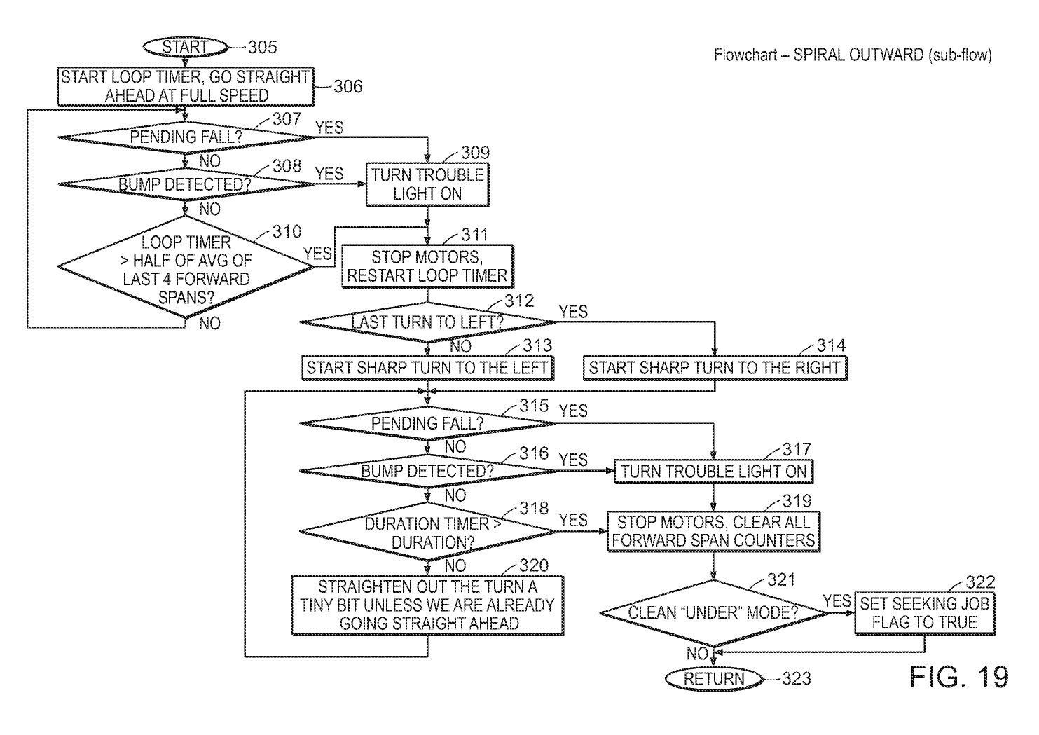

If the previous four forward times have exceeded “Y” seconds, the micro-controller initiates the spiral outward sequence 279 which is shown in further detail in FIG. 19. If the apparatus is not under an object in step 276, the micro-controller checks if the last four forward times have all exceeded “Z” seconds 278 and uses this threshold to determine whether to initiate the spiral outward sequence 279. In the preferred embodiment, the micro-controller sets “Z” to four so that in step 278, the micro-controller determines whether the last four forward times have all exceeded four seconds. The micro-controller can alternatively decide to set “Y” as a different value, such as five. The move forward sequence will continue to loop back to step 263 until a pending fall 263 or bump is detected 264 or until the forward timer has exceeded “X” seconds 275.

In FIG. 18 is a flow chart detailing the forward under step 274 in FIG. 17. After the forward under sequence starts 285, the micro-controller determines if the seeking job flag is set to true 286. If set to true in step 286, the micro-controller then determines if the apparatus is located under an object 287. When under an object, the micro-controller starts a loop timer and directs the motors to move forward at full speed 288. The apparatus will continue to move forward at full speed unless a pending fall is detected 294, triggering the trouble light 297; unless a bump is detected 295, also triggering the trouble light 297; unless the apparatus is no longer under an object 296 or if more than two seconds have passed on the loop timer 298 that was started in step 288. When the loop timer exceeds two seconds in step 298, the micro-controller clears the seeking job flag, restarts the forward timer that was started in step 262 in FIG. 17, and chooses a forward speed between 60 to 100 percent for each motor 299. The micro-controller then starts the heading timer and directs the motors to move forward at the selected speed or speeds 300.

If the apparatus is not seeking a job in step 286, the micro-controller determines whether the apparatus is located under an object 289. If not under an object, 60 percent of the time, the micro-controller will set the forward timer to greater than “A” seconds to cause the forward run to end after the move forward sequence ends in step 303 and 40 percent of the time, the micro-controller will set the seeking job flag to true 301. In the preferred embodiment, the micro-controller sets “A” to 25 so that in step 301, the micro-controller sets the forward timer to greater than 25 seconds 60% of the time. The micro-controller can alternatively decide to set “A” as a different value, such as 60.

If the apparatus is under an object in step 289, the micro-controller determines whether the forward timer is 10 or more seconds greater than the longest recent elapsed forward time 290. The micro-controller records four previous elapsed forward times and compares the present forward timer to these stored values. When the forward timer is greater than 10 seconds longer than the longest recent elapsed forward time, the micro-controller sets the forward timer to greater than “B” seconds 302 to end the forward run after the forward under sequence ends 303. In the preferred embodiment, the micro-controller sets “B” to 25 so that in step 302, the micro-controller sets the forward timer to greater than 25 seconds. The micro-controller can alternatively decide to set “B” as a different value, such as 60.

If the forward timer is not greater than 10 seconds longer than the longest recent forward elapsed time 290 or if the apparatus is seeking a job 286 and is not under an object 287, the micro-controller will check if the heading timer is greater than four seconds 291. When the heading timer exceeds four seconds, 70 percent of the time, the micro-controller chooses a forward speed of 100 percent for both motors and 30 percent of the time, the micro-controller chooses a forward speed of 60 to 100 percent for each motor 292. Once the forward speed is selected, the micro-controller starts the heading timer and directs the motors to operate at the chosen speed 293, thus ending the forward under sequence 303. When the heading timer has not exceeded four seconds in step 291, the forward under sequence is ended 303.

In FIG. 19 is a flow chart showing the spiral outward step 279 in FIG. 17 in further detail. After the spiral outward sequence is started 305, the micro-controller starts the loop timer and directs the motors to both move forward at full speed 306. The micro-controller then determines whether a fall is pending 307 or if a bump has been detected 308, either event causing the trouble light to turn on 309. If neither event has been detected, the micro-controller determines if the loop timer is greater than half the average of the last four forward spans 310. The micro-controller will loop back to step 307 until the loop timer exceeds half of the average of the last four forward spans in step 310. Once the loop timer does exceed half the average of the last four forward spans, the micro-controller stops the motors and restarts the loop timer 311. To increase the randomization of the paths taken by the apparatus, the micro-controller determines the direction of the last turn taken by the apparatus 312 and selects a first turn to the left 313 or right 314 based on it being in the opposite direction to the direction of the previous turn. The apparatus also begins its turn to the left or right in steps 313 and 314, respectively.

As the apparatus moves, the micro-controller checks whether a fall is pending 315 or a bump has been detected by the collision sensors 316, either event causing the trouble light to turn on 317. If the duration timer started in step 222 (in FIG. 15) has not exceeded the duration set by the user in step 209 (in FIG. 14) 318, the apparatus will continue to move forward and slowly reduce the rate at which it is turning 320. When initiating the first sharp turn in steps 313 and 314, the micro-controller directs the inboard motor to stop and the outboard motor to move forward at 100 percent. To reduce the rate at which the apparatus turns, the micro-controller slowly increases the forward rate of the inboard motor (from an initial setting of zero), creating an expanding spiral shaped path.

In step 320, the micro-controller stops and reverses the motors at regular intervals for a short duration. Stopping and reversing the motors at regular intervals during step 320 reduces the possibility of the apparatus becoming stuck on an obstruction for the remainder of the cleaning cycle. In the preferred embodiment, the micro-controller stops the motors every 10 to 20 seconds of spiraling, operates the motors in reverse for a half second to two seconds and then continues forward as before.

When the duration timer exceeds the duration set by the user 318, the micro-controller stops the motors and clears the stored forward span counters 319. The micro-controller then determines if the clean under mode has been selected 321 and if selected, sets the seeking job flag to true 322 prior to ending the sequence 323.

What has been described is an apparatus for automatically cleaning floors. In this disclosure, there are shown and described only the preferred embodiments of the invention, but, as aforementioned, it is to be understood that the invention is capable of use in various other combinations and environments and is capable of changes or modifications within the scope of the inventive concept as expressed herein.

1. (canceled)

2. (canceled)

3. (canceled)

4. (canceled)

5. (canceled)

6. (canceled)

7. (canceled)

8. (canceled)

9. A mobile robot configured to clean a space with a floor and ceiling, comprising:
a drive system capable of moving said apparatus;
at least one upward facing distance sensor in communication with a controller, said upward facing distance sensor configured to detect the distance of surfaces above said apparatus that are lower than said ceiling;
a controller in communication with said drive system, said controller configured to autonomously move said apparatus to areas of said space where the height of surfaces above said apparatus are lower than said ceiling;
a main body where said drive system, controller and upward facing distance sensor are fixed to the main body;
a cleaning pad fixed to the bottom of said main body;
wherein said cleaning pad is circular in shape in a first portion and conforming to the shape of the bottom of said main body in a second portion;
wherein said cleaning pad further comprises cutouts that are triangular in shape extending radially from a point on the bottom edge of said main body to the outer edge of said cleaning pad;
wherein said first portion of said cleaning pad is configured to trail behind said drive system when the apparatus moves in the forward direction;
wherein said upward facing distance sensor is an ultrasonic sensor;
wherein said upward facing distance sensor is further configured to detect surfaces less than one foot above said apparatus;
at least one collision sensor and at least one downward facing distance sensor,
wherein said downward facing distance sensor is an infrared transmitter and receiver; where said controller is configured to calibrate said downward facing sensor for the floor surface characteristics by recording the high values transmitted by the downward facing sensor during a period of operation and setting a normal value based on said high values.

10. The apparatus of claim 9, wherein said drive system comprises at least one electric motor controlled by said controller.

11. (canceled)

12. (canceled)

13. A method of controlling a mobile robot, comprising:
recording and storing forward motion events in a memory of said mobile robot;
selecting a first predetermined number of forward motion events;
selecting a first time value threshold;
comparing the sum of the first predetermined number of most recent forward motion events to said first time value threshold; and
when said sum of the first predetermined number of most recent forward motion events exceeds said first time value threshold, moving said mobile robot in a predetermined pattern.

14. The method of claim 13, where said forward motion events are comprised of the elapsed time of each instance where said mobile robot begins to move forward from a stop until the mobile robot stops moving forward.

15. The method of claim 14, where said first time value threshold is related to the first predetermined number of most recent forward motion events.

16. The method of claim 15, where said predetermined pattern comprises moving said mobile robot in reverse and then causing said robot to rotate about a vertical axis.

17. The method of claim 16, further comprising:
selecting a second time value threshold relating to a second predetermined number of most recent forward motion events;
comparing each said second predetermined number of most recent forward motion events to said second time value; and
where each said second predetermined number of most recent forward motion events exceed said second time value threshold, moving said robot in an expanding spiral about a vertical axis.

18. (canceled)

19. (canceled)

20. A mobile robot configured to clean a space with a floor and ceiling, comprising:
a drive system capable of moving said apparatus;
at least one upward facing distance sensor in communication with a controller, said upward facing distance sensor configured to detect the distance of surfaces above said apparatus that are lower than said ceiling;
a controller in communication with said drive system, said controller configured to autonomously move said apparatus to areas of said space where the height of surfaces above said apparatus are lower than said ceiling;
a main body where said drive system, controller and upward facing distance sensor are fixed to the main body.
at least one collision sensor and at least one downward facing distance sensor,
wherein said downward facing distance sensor is an infrared transmitter and receiver; and
where said controller is configured to calibrate said downward facing sensor for the floor surface characteristics by recording the high values transmitted by the downward facing sensor during a period of operation and setting a normal value based on said high values.
